(19) United States
(12) Patent Application Publication
(10) Pub. No.: US 2007/0030146 A1
(43) Pub. Date: Feb. 8, 2007

(54) Sensor-Based Communications Device Activator

(75) Inventor: James Shepherd, Memphis, TN (US)

Correspondence Address: CHRIS A. CASEIRO, VERRILL DANA, LLP, ONE PORTLAND SQUARE, PORTLAND, ME, 04112-0586, US

(73) Assignee: GPS-911, LLC, Memphis, TN (US)

(21) Appl. No.: 11/461,990

(22) Filed: Aug. 2, 2006

Related U.S. Application Data
(60) Provisional application No. 60/705,130, filed on Aug. 3, 2005.

(51) Int. Cl. G08B 1/08

(52) U.S. Cl. 340/539.1; 340/825.49; 340/539.13; 340/7.5

(57) ABSTRACT

A sensor-based communications device activator, including a first signal transmitting device having a sensor and a second signal transmitting device, which may be preprogrammed to automatically alert emergency rescue personnel to the location of an individual who, due to an emergency, is unable to alert the emergency personnel on his/her own behalf. When one or more stimuli are sensed by the sensor, the activator directs a communications device, optionally including a GPS-based location tracking technologies component, to contact an emergency service. Alternatively, a manual alert device of the activator may be activated by the user to achieve this same result. Whether the communications device is contacted automatically or manually, the emergency service not only will learn that the individual is in danger, but can also learn, via the GPS-based component, the location of the endangered individual.

### CROSS REFERENCE TO RELATED APPLICATION

The present application claims the priority benefit of U.S. provisional patent application serial No. 60/705,130, filed Aug. 3, 2005, entitled “FORCE-BASED CELLULAR TELEPHONE ACTIVATOR” of the same named inventor. The entire contents of that prior application are incorporated herein by reference.

### BACKGROUND OF THE INVENTION

1. Field of the Invention

The present invention relates to sensing devices. More particularly, the present invention relates to sensing devices capable of activating a communications device. Still more particularly, the present invention relates to sensing devices capable of automatically activating a communications device as a function of a stimulus sensed by the sensing device.

2. Description of the Prior Art

The inability to locate victims rapidly in the remains of the World Trade Center of New York, N.Y., on Sep. 11, 2001, was a cause of great distress to their families, friends, colleagues, and others throughout the world. There was no mechanism available at that time for tracking the location of any individual who was unable to activate a communications device within reach and request emergency assistance, such as those individuals who were incapacitated by fallen rubble. Moreover, in some cases in which an endangered individual was able to contact emergency assistance, the individual was unable to provide his/her location to lead emergency personnel to that location. Sadly, if a technology existed which enabled these individuals to be located rapidly, and, in the cases of incapacitated individuals, without action needed to being taken by the individual, some deaths of that day perhaps could have been prevented.

While the events of Sep. 11, 2001, provided a stark example of the limitations of the value of communications devices in an emergency situation, emergency situations during which an individual cannot activate a cellular telephone, or other communications device, contact the appropriate emergency assistance, or designate a location, are an everyday occurrence. For example, consider a motorcycle rider involved in an accident on an unidentified road, a driver whose vehicle has plunged into water, or even a person, such as a coal miner, who is unknowingly being exposed to dangerous levels of carbon monoxide. Also, police officers, fire fighters, and the nation's military and other security forces, many of whom travel alone and are at an elevated risk of suffering an injury far from help, are particularly susceptible to being caught in a situation of this kind.

OnStar® technology, owned and operated by General Motors of Detroit, Mich., is an integrated satellite-based vehicle system that takes advantage of existing Global Positioning Satellite (GPS) signals to enable identification of the location of a vehicle, and to transmit that information to a remote location, such as a call center, via wireless communication. The OnStar® system apparently requires implementation in the vehicle of a GPS receiver and a communication system tied to the call center. The system is a subscription-based service, permitting selective voice communication with the vehicle's driver or passenger. Alternatively, it may be automatically activated upon deployment of the vehicle's air bag. That is, the air bag deployment triggers an electronic signal to activate the communication system. The OnStar® call center receives the system activation signal, identifies the vehicle's location, calls, or attempts to call the vehicle occupant(s), and then contacts emergency services, if applicable, with vehicle location information. There may be other vehicle-based location and communication systems the equivalent of the OnStar® system.

There are significant limitations associated with vehicle-based location and communication systems such as the OnStar® system. Specifically, it is limited not only to vehicles, but also to vehicles having a GPS receiver and some form of wireless communication system. Therefore, any individual on foot or in any type of vehicle without those components cannot take advantage of its capability. Second, to be kept activated, it requires a regular subscription service. Any failure or error in upkeep of the subscription eliminates the location and communication capability. Third, and perhaps most importantly, any event rendering the user unable to communicate without causing the air bag to deploy will not activate the location and communication system. There are many types of force-based events that happen to individuals, in or out of a vehicle, which would not cause air bag deployment. It therefore is apparent that there are a variety of situations during which an OnStar® system or its equivalent would not be of use in getting an emergency responder to an individual unable to contact the responder and/or identify his or her location.

Communications devices are available with integrated GPS receivers, wherein the receivers can be used to identify the location of the receiver. Moreover, in conjunction with the goal through enhanced 911 emergency services to be able to identify the location of an emergency caller, the Federal Communications Commission has ruled that cellular telephone signal carriers must be able to track cellular telephone location. That capability will involve the use of GPS receivers in the handsets themselves, easier cellular telephone triangulation technology, or some combination of the two. As a result, it should soon be possible to track the location of any cellular telephone. This will be of great value to any individual who cannot identify his or her location but is still able to activate the cellular telephone and call emergency services. Unfortunately, it fails to address the need of any individual who is unable to make the initial contact with emergency services.

Therefore, what is needed is an electronic system or device that provides an individual with a mechanism for activating a communications device, contacting emergency services or other, preprogrammed contacts designated by the individual, and sending a preprogrammed message or message that identifies the location of the communications device (and, thus, the individual), all after the individual has experienced a stimulus rendering him or her unable to undertake any of the noted steps. What is also needed is such a system or device that takes advantage of existing technologies, including existing location—based cellular telephone location tracking technologies. Further, what is needed is such a system or device that is not restricted to specific integration into a vehicle location and communication system.

### SUMMARY OF THE INVENTION

It is an object of the present invention to provide an electronic system or device that provides an individual with a mechanism for activating a communications device, contacting emergency services or other preprogrammed contacts, and sending a preprogrammed message or message that identifies the location of the communications device, all after the individual has experienced an event rendering him or her unable to undertake any of the noted steps. It is also an object of the present invention to provide such a system or device that takes advantage of existing technologies, including existing location -based communications device location tracking technologies, such as GPS. Further, it is an object of the present invention to provide such a system or device that is not restricted to specific integration into another system, such as a vehicle location and communication system.

These and other objects are achieved with the present invention, which is a sensor-based communications device activator for signaling the communications device to contact one or more emergency services upon receipt of an electronic signal in response to a stimulus detected by a sensor of the activator. The sensor may be, for example, a piezoelectric chip or an accelerator chip. Upon receiving a first signal from a first transmitting device, which is the sensor or which includes the sensor, the second transmitting device enables a user's communications device to be remotely activated. The second transmitting device effectively translates the electrical signal from the first transmitting device into a second signal capable of initiating a communicative transmission from the user's communications device. The activator of the present invention is a portable safety device that enables one's communications device to serve as a survival tool by communicating the user's location when he or she cannot.

The second transmitting device is a battery operated electrical device, preferably housed in a plastic, water-resistant container to which the lead wires of the stimulus-sensing device, or other signal-interface device, are connected. When the sensor is stimulated, the first transmitting device sends a first signal to the second transmitting device. The second transmitting device interprets that signal to evaluate whether the stimulus is sufficient enough to activate the communications device. The types of stimuli required to activate the communications device may vary. For example, the types of stimuli detectable by the sensor include, but are not limited to being, a blunt force to the sensing device, sound, change in temperature, change in humidity, exposure of the sensing device to water, presence of smoke, presence of a particular gas, such as carbon monoxide, and absence of a particular gas, such as oxygen. Moreover, the threshold magnitude of these stimuli needed to cause the first transmitting device to signal the second transmitting device may vary. For example, if the sensing device is designed to sense blunt force, the threshold amount of force required to cause the sensing device to transmit a signal to the translator may be small, such as the amount of force which the sensing device may receive when it is dropped to the ground from a short distance, or it may be large, such as the amount of force which the sensing device may receive in a violent collision involving a motor vehicle. If the specified threshold magnitude of the stimulus is met, the translator transmits a signal to the user's communications device. Otherwise, no signal is transmitted from the first transmitting device. The communications device, upon receiving the signal, contacts a remote communications receiving device, and preferably one which is associated with an emergency service. For example, where a cellular phone is the communications device of the activator, the phone may be preprogrammed to dial emergency services or any preprogrammed contacts. The communications device may provide for a pre-call warning to permit cancellation of the call in a non-emergency event.

Products which may be used as the sensor are currently available, as are products which may serve as the communications device, such as a cell phone, a pager, and an e-mail transmitting device. The present invention bridges otherwise unrelated sensor and communication products by translating data from the first transmitting device, preferably wirelessly, but optionally in a wired arrangement, into a signal that instructs the communications device to contact emergency services. The present invention differs from OnStar® technology in that it is a portable device whereas OnStar® is a permanent device which must be associated with the user's automobile. The system of the present invention including the first transmitting device can be applied to any surface that may encounter a stimulus, such as on an individual's person, on a surface which is near a particular individual, and as part of a motor vehicle's bumper system. Provided that the user's communications device is within electrical or wireless contact with the invention, the stimulus will cause the communications device to contact emergency services. People who ride motorcycles, snowmobiles, automobiles not equipped with OnStar® technology, or even farming equipment, run the risk of not having the ability to call for help if they are injured. The present invention provides a means to communicate one's location when confronted with a dangerous situation.

### BRIEF DESCRIPTION OF THE DRAWINGS

FIG. 1 is a simplified diagrammatic representation of the sensor-based communications device activator of the present invention in communication with a communications device, which, in turn, is in communication with a remote communication receiving device.

FIG. 2 is a front perspective view of the second transmitting device of the sensor-based communications device activator of the present invention.

FIG. 3 is a rear perspective view of the second transmitting device of the sensor-based communications device activator of the present invention.

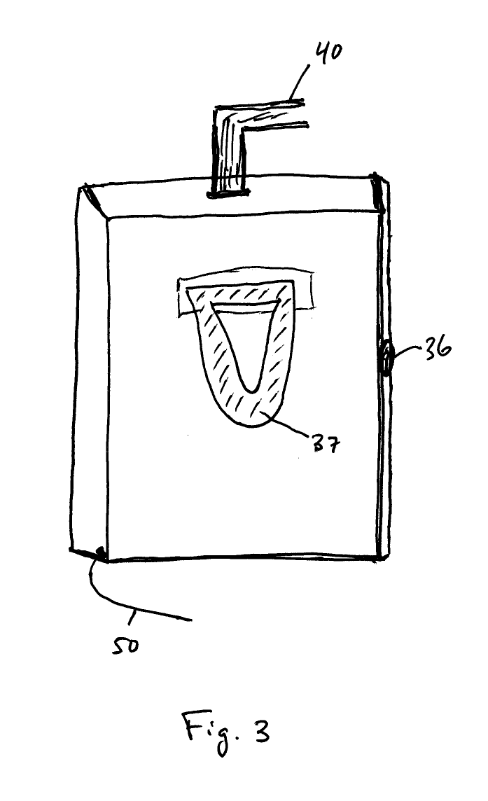

### DETAILED DESCRIPTION OF THE PREFERRED EMBODIMENT

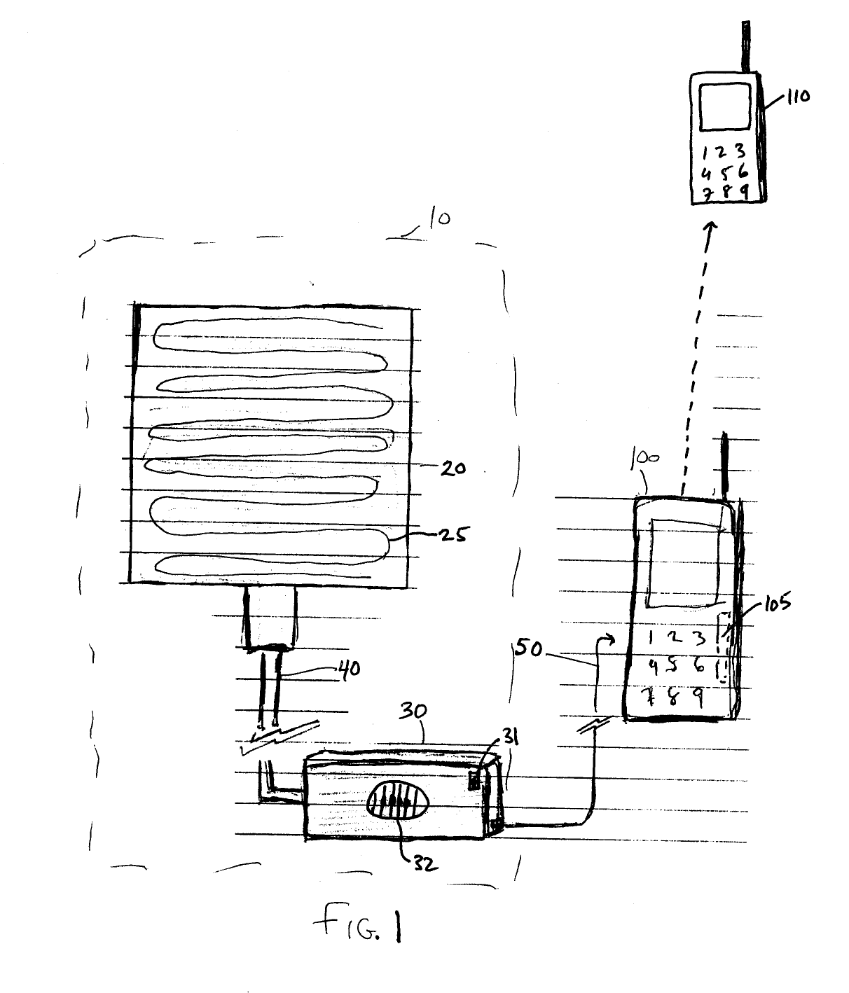

FIG. 1 provides a simplified representation of a sensor-based communications device activator 10 in communication with one or more communications devices 100. The activator 10 includes a first signal transmitting device 20 having a sensor 25, and a second signal transmitting device 30. The first signal transmitting device 20 is connected to the second signal transmitting device 30 through a wiring harness 40. The sensor 25 is capable of sensing one or more external stimuli and the first signal transmitting device 20 is capable of automatically transmitting a first signal through a first signal transfer medium 22, such as a first wire, upon this sensing of the stimulus or stimuli. The second signal transmitting device 30 is capable of receiving and processing the first signal and transmitting a second signal through a second signal transfer medium, such as a second wire 32. The communications device 100 is capable of receiving and processing the second signal, and transmitting a third signal through a third signal transfer medium, such as air for a wireless communicator. The third signal may be received by one or more remote communication receiving devices 110. Upon receipt of the third signal, the remote communication receiving device 110. In this arrangement, the activator 10 is useful for automatically informing individuals associated with the remote communication receiving device 110, such as emergency personnel, of the location of the activator 10 user when the user becomes endangered.

All components of the activator 10 are preferably lightweight yet sufficiently robust to remain intact and functional after being exposed to the stimulus or stimuli. Therefore, each of the first signal transmitting device 20, the sensor 25, the wiring harness 40, and the second transmitting device 30 are preferably housed in a robust housing, such as a container having high load resistance and which is capable of withstanding environmental conditions, such as heat, water, and collision with a hard object, that otherwise may destroy the function of these components.

The sensor 25 may be arranged to detect any one or more of a variety of stimuli. For example, the sensor 25 may detect, but is not limited to detecting, blunt force to the first signal transmitting device 20, such as that which may occur to the first signal transmitting device 20 when the user of the activator 10 is involved in a motor vehicle collision. The sensor 25 also may detect, but is not limited to detecting, exposure of the first signal transmitting device 20 to liquid, such as that which may occur to the first signal transmitting device 20 when the user of the activator 10 plunges into a body of water. As another example, the sensor 25 may detect, but is not limited to detecting, change in ambient air temperature or level of humidity near the first signal transmitting device 20, such as that which may occur when the user of the activator 10 is exposed to fire or release of steam. In yet another example, the sensor 25 may detect, but is not limited to detecting, absence or presence of a particular gas, such as the absence of oxygen or the presence of carbon monoxide, in the ambient air surrounding the first signal transmitting device 20, which are environmental conditions that the first signal transmitting device 20 might become exposed to when the user of the activator 10 is trapped in a coal mine.

Since the sensor 25 potentially may detect a large number of diverse stimuli, several devices may serve as the sensor 25 or several detecting components may be embodied in a single device. For example, the sensor 25 may be, but is not limited to being, a piezoelectric chip or an accelerator chip. As another example, the sensor 25 may be a Force Sensing Resistor® (“FSR”) available from Interlink Electronics, Inc., of Camarillo, Calif.

Further, since the activator 10 potentially may detect a number of diverse stimuli, the activator 10 may include more than one sensor 25. For example, the activator may include a sensor 25 that is capable of detecting blunt force, a sensor 25 that is capable of detecting carbon monoxide, and a sensor 25 that is capable of detecting smoke. Whenever the activator 10 includes more than one sensor 25, the first transmitting device 20 will transmit the first signal whenever any one or more of the sensors 25 detects a stimulus or stimuli equal to or greater than the preselected threshold value associated with the stimulus or stimuli detected.

The first signal transmitting device 20 may be optimally positioned to detect the stimulus when the activator 10 is being used. Therefore, the first signal transmitting device 20 may be of selectable design characteristics. Specifically, the first signal transmitting device 20 may be shaped to conform with the surface to which it is applied, such as the inside of a helmet, the surface of a jacket or shirt, on a bulletproof vest, or on a component of a vehicle's bumper system.

When the sensor 25 detects a stimulus, the first transmitting device 20 may, but need not, transmit the first signal. One reason why the first signal may not be transmitted in response to the stimulus is that the stimulus is not of a selectable threshold value. This ability to select this threshold value, which selection may be changed when desired, is a valuable feature of the activator 10 of the present invention because it effectively prevents the activator 10 from being overly sensitive, and therefore from signaling the remote communications receiving device 110 when the user of the activator 10 is not caught in an emergency situation. For example, where the activator 10 is meant to sense carbon monoxide, such as for the purpose of alerting emergency personnel when a coal miner is in danger of being asphyxiated, the activator 10 might be considered overly sensitive if, for example, it alerts these personnel whenever there is a slight increase in the percentage of carbon monoxide in the air. This might be problematic, for example, when a coal miner, who is outside of a mine, passes an idling automobile. Therefore, in keeping with this example, the activator 10 is advantageous because it can be preset to allow the third signal to be transmitted only in response to a dangerous level of carbon monoxide, such as what the miner might become exposed to while in a mine, and not transmitting the third signal when the sensor 25 detects a safe level of carbon monoxide, such as what humans typically are exposed to while walking near automobile traffic.

The second signal transmitting device 30 is battery powered and includes electronic circuitry programmed to receive the first signal, determine whether the first signal satisfies a specific condition to cause activation of the communications device 100, such as a selected threshold-level or greater output voltage value from the first signal transmitting device 20, and transmit the second signal to the communications device 100.

The communications device 100 may be any device that is capable of receiving and processing the second signal, and transmitting the third signal. For example, the communications device 100 may be, but is not limited to being, a telephone, such as a cellular telephone, a paging device, or a multipurpose wireless communicator, such as the BlackBerry® product commercially available from Research In Motion Limited of Waterloo, Ontario (Canada), and the HP iPAQ hw6515 Pocket PC product commercially available from Hewlett-Packard Company of Palo Alto, Calif. (USA).

A communication interface 50 of activator 10, through which the second signal is transmitted, may be a wired interface. Alternatively, it may be a wireless interface, such as a relatively short-distance protocol-based communication. For example, it may be an IEEE 802.11 wireless interface protocol or a Bluetooth wireless protocol. The second signal transmitted from the second signal transmitting device 30 through the communication interface 50 provides instructions to the communications device 100 to contact one or more remote communication receiving devices 110 associated with e911, or other emergency services of interest. The communication interface 50 may produce signals at 900/1800 MHz (DCS) and/or 1900 MHz (PCS), but is not limited thereto and it is to be understood that any communication system may be employed. The communications device 100 must be of a type capable of automatically enabling location identification information.

The first signal transmitting device 20 and the second signal transmitting device 30 may be configured and arranged to include a computing system for performing functions and steps embodied in computer instructions stored and accessed in any one or more of the manners described for the purpose of signaling the communications device 100. The first signal transmitting device 20 and the second signal transmitting device 30 may be embodied in a single computing system, such as an integrated circuitry system electrically couplable to sensors 25 as described herein. Alternatively, the first signal transmitting device 20 and the second signal transmitting device 30 may be embodied in separate computing systems, although they may be physically located near one another and in signal communication with one another. In particular, the signal communication between the first signal transmitting device 20 and the second signal transmitting device 30 may include, but not be limited to, the output by the first signal transmitting device of an electrical signal of selectable amplitude, frequency, voltage, current or combinations thereof, and the configuration of the second transmitting device 30 to receive that signal and process it for further signal transmitting, as applicable.

The computing system of either or both of the first signal transmitting device 20 and the second signal transmitting device 30 may be of any type with sufficient computing functionality to read computer-readable signals tangibly embodied on a computer-readable medium, including, but not limited to, wireless exchange media. The present invention includes computer programming of the computing system used to control and enable the first signal transmitting device 20 and the second signal transmitting device 30. The computer programming defines instructions for processing data obtained from the sensor 25, if needed, for the second transmitting device 30 to process the first signal transmitted by the first signal transmitting device 20, and for the second transmitting device 30 to transmit the second signal to the communications device 100. Such computer programming instructions may be written in any of a plurality of programming languages, for example, Java, XML Visual Basic, C, or C++, Fortran, Pascal, Eiffel, Basic, COBOL, and the like, or any of a variety of combinations thereof. The computer-readable medium on which such instructions preferably reside is readable by the computing system.

The signal exchange between the sensor 25 and the first signal transmitting device 20, and the signal exchange between the first signal transmitting device 20 and the second signal transmitting device 30 may be well understood by those skilled in the art, in which the signal exchange may be based primarily on reaching selectable threshold electrical signal values. The step of the process of the present invention involving the activation of the communication device 100 by the second signal transmitting device 30 is described in greater detail herein, in which an example embodiment is presented to describe one particular mechanism for activation of the communication device 100. However, it is to be understood that the process of activating the communication device 100 through signaling by the second signal transmitting device 30 is not limited to this example.

### EXAMPLE

Devices used

The communications device 100 chosen for this Example was an HP iPAQ hw6515 Pocket PC, and the second transmitting device 30 was established on a circuit bread board 39. model C.A.D.E.T. II Ruggedized Electronic Circuit Trainer product commercially available from E&L Instruments of Cheshire, Conn. (USA). Commercially available software used included Visual Studio .NET 2003, ActiveSync, eMbedded Visual C++4.0, all of which are available from Microsoft® Corporation of Redmond, Wash. (USA).

Transmission of the second signal

The second transmitting device 30 was programmed to transmit the second signal to the communications device 100 whenever the Protocol shown below was carried out.

Protocol

The computer programming was written to perform the steps of activating the communication device 100 to initiate a call without physically pressing any one or more buttons of the communication device 100. Instead, the programming activated the communication device 100 to place a call to a selectable external device, such as the remote communication receiving device 110 upon reception of an external signal, represented as the second signal of the second signal transmitting device 30. This functionality was programmed in the Example in two parts. The first was to create instructions to place a call by merely executing a program. The second part was to create instructions to read an incoming signal off one of the input/output ports of the communication device 100. Upon completion of the two instructional parts, they were then meshed together such that the instructions to place a call would be activated after the processing of the instructions for reading the incoming signal.

The Example programming begins with a list of inclusions that a C++ compiler will recognize in performance of following instructions. These inclusions are:

#include “stdafx.h”
#include <windows.h>
#include <commctrl.h>
#include <phone.h>
int WINAPI WinMain( HINSTANCE hInstance,

HINSTANCE hPrevInstance,

LPTSTR lpCmdLine,
int nCmdShow)

The “phone.h” inclusion contains all of the commands necessary pertaining to the phone call. The other inclusions and the opening “int WINAPI WinMain” are established upon the creation of a workspace, with the WinMain file containing smaller, more detailed, aspects of the program.

The Example programming next includes instructions for receiving the incoming signal (the second signal from the second transmitting device 30) to begin activation of the communication device 100 to place a call. These next instructions include:

DWORD dwModemStatus;

// Open the port here using CreateFile, setup its DCB, timeouts, etc.

HANDLE hCOM = CreateFile( TEXT(“COM1:”),

GENERIC_READ | GENERIC_WRITE,
FILE_SHARE_READ,
NULL, // default security attributes
OPEN_EXISTING,
FILE_FLAG_OVERLAPPED,
NULL
);

Through these instructions, the selectable communication port of the communication device 100 that is going to read the incoming signal is opened using the command CreateFile. This function opens the already existing port COM1 which is the serial port on the bottom of the hp ipaq hw6515a phone. The CreateFile has several parameters that need to be set before it can successfully open the communication port. The parameters are set as is shown in the above instructions; the function opens the existing COM1 port for reading and writing.

The following instructions establish the condition for monitoring the communication port of the communication device 100 for signal reception:

if(!SetCommMask (hCOM, EV_DSR | EV_CTS))
{

return 0;

}

The “SetCommMask” instruction specifies a set of events to be monitored for the communication device 100. This instruction set establishes that if the SetCommMask function fails, there will be a return 0, triggering termination of the program. The “EV_DSR|EV_CTS” parameter defines whether the communication port status has changed.

The following instructions define a status check loop for detecting an incoming signal on the communication port of the communication device 100:

while (1)
{

DWORD dwEvent;
if (!WaitCommEvent(hCOM, &dwEvent, NULL))
{

// Perhaps the COM port was closed from another thread,
so need to exit the loop
break;

}
// Check if state of the DSR or CTS signals has changed
if(dwEvent & (EV_DSR | EV_CTS))
{

This instruction set establishes a busy wait status loop. Beginning with the “while(1)” statement, an infinite loop is created that will continue to cycle until it is broken. Inside the loop is another function that will test to see if the COM1 Port is functioning correctly. If the “WaitCommEvent” function fails, the loop is broken by the “break;” statement and the program ends. If the port is behaving appropriately, the loop steps into the next if statement, which is a check to determine whether the state of the DSR or CTS input has changed. That is, whether the second signal from the second signal transmitting device 30 has been received at the COM1 port. If it has, the “if” statement instruction is activated to initiate a call, otherwise the loop continues to check this statement infinitely until there is a change. This completes the first part of the Example.

The final set of instructions, embodying the second part of the Example, perform the function of making the call to one or more remote communications devices 110:

PHONEMAKECALLINFO info;
memset(&info, 0, sizeof(info));
info.cbSize = sizeof(info);
info.dwFlags = PMCF_PROMPTBEFORECALLING;
info.pszDestAddress = TEXT(“2075555555”);
if (!PhoneMakeCall(&info))
{

return 0;

}

break;

}

}

return 0;

}

These instructions activate the communication device 100 to call an existing function within the phone.h inclusion, such as the number of a remote communications device 110. To use the function a “handle” must be created and in the instructions of the Example, this handle is called “info”. Memory of the computing system of the communications device 100 is set aside using “memset” for the information required of the PHONEMAKECALLINFO structure. The size is declared, an option is provided to allow the user to place the call immediately or confirm it (although the system is arranged otherwise to make the call automatically upon the triggering condition being met), and finally the destination address itself is stored in memory. The “PhoneMakeCall” if statement is then performed, resulting in the dialing of the destination address. A successful phone call steps to the “break;” function which exits the loop and returns the program to the “return 0” instruction, which will close “WinMain”, the main program.

It will be recognized by those skilled in the art of computer programming that alternative instructional sets may be programmed without deviating from the principal steps of: 1) monitoring the communication device 100 for receipt at a communication port thereof a signal from the second signal transmitting device 30; and 2) initiating a call from the communication device 100 upon receipt of that signal.

It is also contemplated that the activator 10 may be designed to signal more than one communications device 100. For example, the activator 10 may be used to signal both a cellular phone and a paging device. The ability to contact more than one communications device 100 would be valuable to better ensure that the remote communication receiving device 110 will be contacted in an emergency. For example, the activator 10 may be needed in situations in which one of the communications devices 100 is lost or destroyed, such as during the emergency event itself, or is inoperable, such as when that device's battery is in need of charging, or when that device is otherwise incapable of establishing contact with a particular remote communication receiving device 110.

The ability to signal the remote communication receiving device 110 that a particular user of the activator 10 is in need of help is only one attribute of the activator 10. Another feature of the activator 10 is that it is able to automatically direct, that is without any overt action by the user, anyone associated with the remote communication receiving device 110 to the location of the user. Specifically, the activator 10 optionally includes a GPS-based device 105 to provide this function. The GPS-based device 105 may be associated with either or any of the first signal transmitting device 20, the second signal transmitting device 30, and the communications device 100. It may be any of the GPS-based devices known to those skilled in the art of GPS-based device manufacture. In this arrangement, the third signal provides the global position of the communications device 100 to the remote communication receiving device 110 through conventional location-positioning technology.

The remote communication receiving device 110 may be any device capable of receiving the third signal and alerting an individual associated with the remote communication receiving device 110 that the user associated with the activator 10 may be in need of help, and providing information regarding the location of the communications device 100 to that individual. Therefore, the remote communication receiving device 110 may be, but is not limited to being, a telephone or a computer system.

Further, the remote communication receiving device 110 may be more than device. For example, the remote communication receiving device 110 may include a cellular telephone tower, such as one which may receive the third signal when a cellular phone is being used as the communications device 100, and may include a telephone, such as one which may be present at the location of the emergency service being contacted. It is therefore contemplated that the remote communication receiving device 110 may be any single device or combination of devices that is able to effectively transmit the third signal to the remote communication receiving device 110 after the third signal has been transmitted by the communication receiving device 110.

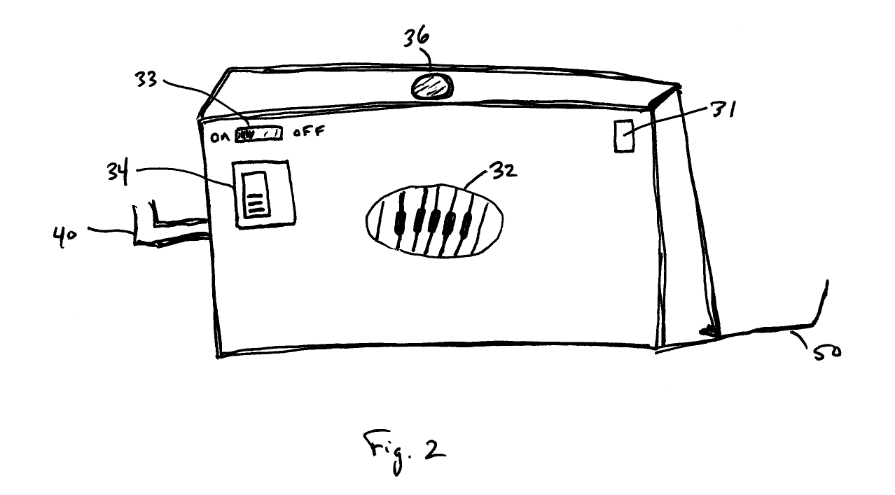

As shown in FIG. 2, the second transmitting device 30, or some other component of the activator 10, may be equipped with a status indicator 31, such as an LED, capable of confirming to the user whether the activator 10 is in proper communication with the communications device 100 and/or capable of confirming that all of the various components of the activator 10 are working properly. For example, where an LED is the status indicator 31, the LED may produce a signal, such as a green light, when the activator 10 and the communications device 100 are in proper communication or when the activator 10 itself is properly functioning, and may produce an alterative signal, such as a yellow light, when the activator 10 and the communications device 100 are not in proper communication or when the activator 10 is malfunctioning. As another example, the status indicator 31 may be a device that is capable of producing a sound. When a sound-emitting device, such as a speaker 32, is used as the status indicator 31, the status indicator 31 may emit a sound, or series of sounds, having a distinct tone, for example, whenever proper communication between the activator 10 the communications device 100 is lost or the activator 10 is malfunctioning.

As shown in FIG. 2, the activator 10 may include components other than the status indicator to aid the user. For example, the activator 10 may include a power switch, button, or similar device 33 for turning the activator 10 on and off, a power indicator 34, a text-to-speech synthesizing program, which may be used in conjunction with the speaker 32, a belt clip or other personal attachment device 37 for attaching one or more parts of the activator 10 to the user's person, and/or an manual alert switch, button, or similar device 36 which, when manually activated by the user, may effectively transmit the second signal to the communications device 100 for the purpose of having the communications device 100 instruct the remote communications receiving device 110 that the user is in need of help. Any one or all of these components may be on any part of the activator 10.

Further, the function of any or all of these components may be optimized to best serve the user. For example, where a depressible button is included as the manual alert device 36, the button 36 may be designed such that it effects transmission of the second signal only after the button 36 has been continuously depressed for a given period of time, for example, two seconds, to prevent the second signal from being transmitted when the button 36 is unintentionally and briefly depressed. The activator 10 further optionally includes a manual cancellation device, such as may be represented by button 36, to enable a halt in the transmission of the second signal such when, for example, a triggering condition may have occurred but the individual remains able to initiate a communication without assistance.

As another example, where the activator 10 includes the speaker 32 and the text-to-speech synthesizer program, the text-to-speech synthesizer program may effect verbal messages through the speaker 32 to the user, such as those regarding the performance of the device or those sent by remotes individuals, through the speaker 32. For example, the text-to-speech synthesizer program may effect the verbal message, “Warning, low battery,” when the activator's 10 power level is low, and it may also effect the verbal message, “Please remain calm. Help is on the way,” when signaled to do so by remote individuals. Messages which may be effected by the text-to-speech synthesizer program, however, are not limited to these examples.

In yet another example, the power indicator 34 may be designed to indicate only that either the power level of the activator 10 is sufficient or insufficient, or it may provide more detailed information regarding the power level. For example, an LED may serve as the power indicator 34 and may appear, for example, green when the power is sufficient, and may appear yellow when the power level falls below a selectable threshold. In an alternative example, the LED may be capable of displaying a plurality of icons, each of which provides more specific information regarding the power level. For example, the power indicator 34 may display the icon “75%” when the power level is decreased by 25 with respect to the maximum level, or it may display some other icon, such as a broad filled line which appears more and more unfilled as the power level decreases.

This detailed description is not intended to limit the principle concept of the present invention as a sensor-based communications device activation system. All equivalents are deemed to fall within the scope of this description of the invention. Therefore, it is to be understood that it includes all reasonable equivalents thereof as defined by the following appended claims.

What is claimed is:

1. A sensor-based communication device activator, comprising:
a. a first signal transmitting device having at least one sensor, wherein each of the at least one sensors is capable of detecting at least one stimulus and wherein the signal transmitting device is capable of automatically transmitting a first signal upon the detection of the at least one stimulus; and
b. a second signal transmitting device, wherein the second signal transmitting device is capable of receiving the first signal transmitted by the first signal transmitting device and is capable of transmitting at least one second signal to a communications device.

2. The activator of claim 1 wherein the communications device is capable of communicating with more than one remote communications device.

3. The activator of claim 1 wherein the communications device is selected from a group consisting of a cellular telephone, a pager, a BlackBerry® and an HP iPAQ hw6515 Pocket PC.

4. The activator of claim 1 wherein the second signal transmitting device and the communications device is connectable by wiring, and the second signal is transmitted from the second signal transmitting device to the at least one communication device through the wiring.

5. The activator of claim 1 wherein the second signal transmitting device and the communications device are not physically connected to each other, and the second signal is transmitted from the second signal transmitting device to the communications device wirelessly.

6. The activator of claim 1 wherein the communications device includes a Global Positioning System-based device.

7. The activator of claim 6 wherein the communications device is arranged to transmit its position to at least one remote communications receiving device.

8. The activator of claim 7 wherein at least one of the at least one remote communications receiving device is associated with at least one emergency response service.

9. The activator of claim 1 wherein the at least one sensor is a piezoelectric chip.

10. The activator of claim 1 wherein the at least one sensor is an accelerator chip.

11. The activator of claim 1 wherein the at least one sensor is a force-sensing resistor.

12. The activator of claim 1 wherein the at least one stimulus is selected from the group consisting of blunt force to the at least one sensor, exposure of the at least one sensor to liquid, change in ambient temperature around the at least one sensor, change in ambient humidity around the at least one sensor, presence of one or more particular gases in the ambient air around the at least one sensor, and absence of one or more particular gases in the ambient air around the at least one sensor.

13. The activator of claim 1 wherein the nature of the at least one stimulus required to effect the transmission of the at least one first signal is variable and preselectable.

14. The activator of claim 1 wherein the first signal transmitting device is connected to the second signal transmitting device via a wiring harness.

15. The activator of claim 1 including at least one indicator, wherein the at least one indicator is capable of providing information regarding the performance of the activator to the user of the activator.

16. The activator of claim 15 wherein the at least one indicator is an LED.

17. The activator of claim 15 wherein the at least one indicator is a sound-emitting device.

19. The activator of claim 1 including a manual alert device, wherein activation of the manual alert device by an individual causes the second signal to be transmitted from the second transmitting device.

20. The activator of claim 1 further comprising a manual cancellation device to enable an individual to halt transmission of the second signal.
